(19) United States
(12) Patent Application Publication
(10) Pub. No.: US 2016/0113316 A1
(43) Pub. Date: Apr. 28, 2016

(54) SWEETENING COMPOSITION

(71) Applicant: Red Bull GmbH, Fuschl am See (AT)

(72) Inventors: Josef NACHBAGAUER, Hallein (AT); Heidemarie GANSCH, Fuschl am See (AT); Lydia GOEHLER, Mondsee (AT); Sabrina HABRING, Frankenburg (AT); Nicole PABI, Fuschl (AT)

(21) Appl. No.: 14/923,304

(22) Filed: Oct. 26, 2015

(30) Foreign Application Priority Data
Oct. 24, 2014 (EP) 14 19 0293.2

(51) Int. Cl. A23L 1/236; A23L 2/54; A23L 2/60

(52) U.S. Cl. CPC A23L 1/2363; A23L 1/2364; A23L 1/2366; A23L 2/60; A23L 2/54; A23V 2002/00

(57) ABSTRACT

The present disclosure relates to a sweetening composition comprising rebaudioside A, rebaudioside B and rebaudioside D wherein, based on the total weight of rebaudioside A, rebaudioside B and rebaudioside D, rebaudioside A is present in an amount in the range from 85.0 to 95.0 wt-%, rebaudioside B is present in an amount in the range from 0.2 to 1.2 wt-%, and rebaudioside D is present in an amount in the range from 4.8 to 13.8 wt-%, and also to a sweetening composition comprising rebaudioside A, rebaudioside B, rebaudioside D and at least one natural sweet-tasting carbohydrate, in particular a natural sweet-tasting monosaccharide and/or disaccharide, and/or at least one sweet-tasting sugar alcohol. Moreover, the present disclosure is about the use of said sweetening compositions for sweetening and preparing beverages as well as for preparing syrups as precursors and for the preparation of such beverages. The invention is also about a beverage comprising said sweetening compositions as well as about a process for preparing such beverage.

### BACKGROUND

1. Technical Field

The present disclosure relates to sweetening compositions, their use for the preparation of sweetening syrups and beverages as well as to the preparation of said beverages.

2. Description of the Related Art

Common soft drinks usually contain significant amounts of natural sugars such as sucrose, glucose, fructose or mixtures thereof. The caloric content of these natural sugars is in the range from 3.6 to 3.9 kcal/g. Many attempts have been made to reduce the caloric content of beverages such as soft drinks. In some instances natural sugars have been replaced by artificial sweeteners such as aspartame or acesulfame potassium. These artificial sweeteners usually are synthetic compounds having no resemblance to the structure of natural sugars. Another supplement to said natural sugars are sucralose, which is a chlorinated carbohydrate, and steviol glycosides. Both of these sweeteners are experiencing a still increasing demand due to their very low caloric content. Moreover, some steviol glycosides have a sweetening power which is about 240 to 400 times that of the natural sugar sucrose. Steviol glycosides are derived from extracts of the leaves of the stevia plant (Stevia rebaudiana Bertoni). The four major steviol glycosides found in the leaves of the stevia plant are stevioside (about 5 to 10 wt-%), rebaudioside A (about 2 to 4 wt-%), rebaudioside C (about 1 to 2 wt-%) and dulcoside A (about 0.5 to 1 wt-%). Further steviol glycosides which are found in the extract of the leaves of the stevia plant, however in rather minute quantities, are rebaudioside B, rebaudioside D and rebaudioside E. The common aglycon of all steviol glycosides is steviol which belongs to the class of diterpenes.

Unfortunately, beverages sweetened with steviol glycosides suffer some significant drawbacks which for many consumers outweigh the high caloric content of conventional beverages. Steviol glycosides are known to cause a bitter and/or licorice-like aftertaste, in some instances also a metallic aftertaste. In addition, the sweet sensation is retarded to a significant extent, that is, the sweetening has a significant onset time. In some cases steviol glycosides are also responsible for a so-called blunt or dry mouthfeel.

Many attempts have been made to overcome the afore-mentioned shortcomings. For example, according to WO 2012/073121 A2 the bitter aftertaste of steviol glycosides shall be decreased or eliminated by the reduction or elimination of rebaudioside C or dulcoside A or both from stevia compositions. However, it has been found that the reduction of rebaudioside C and/or dulcoside A as such does not guarantee a reduction in bitter aftertaste. Moreover, even with stevia compositions being void of rebaudioside C or dulcoside A consumers experience a slow onset and sometimes even a longer duration of the sweetness sensation.

In WO 2008/147726 it is described that a more sugar-like flavor profile shall be obtained by sweetener compositions comprising at least a) one sweetness enhancer such as urea or thiourea, b) at least one sweetener comprising a carbohydrate sweetener, a natural high-potency sweetener, a synthetic high-potency sweetener or a combination thereof such as rebaudioside compounds, sucralose, aspartame or acesulfame potassium, and c) at least one sweet taste improving composition selected from the group consisting of carbohydrates, polyols, amino acids, or mixtures thereof.

New sweetened beverage formulations which do not exhibit a bitter aftertaste shall be obtained according to EP 2 474 240 A1 by use of rebaudioside D and an acidulant comprising at least lactic acid and one or both of tartaric acid and citric acid, and no phosphoric acid.

From WO 2011/146463 A2 it can be derived that the bitterness in an otherwise sweet composition containing steviol glycosides shall be masked by incorporating an increased amount, relative to naturally occurring compositions, of rebaudioside D.

EP 2 486 806 A1 discloses a low-calorie orange juice drink which makes use of a mixture of 84 wt-% rebaudioside A and 16 wt-% rebaudioside D. Different from a low-calorie orange juice having been sweetened with a conventional stevia extract a pleasant taste similar to sucrose, a full mouthfeel, and no bitterness and no aftertaste could be observed during sensory evaluation. A similar outcome was observed for a zero-calorie carbonated beverage.

According to WO 2008/112967 A1 the metallic aftertaste experienced with beverages containing conventional steviol glycosides shall be masked by the presence of anisic acid.

And, in WO 2012/109585 A1 it is disclosed that attributes such as bitterness, sweet aftertaste and licorice flavor of steviol glycosides may be overcome by sweetening compositions comprising a blend of rebaudioside A, rebaudioside B and steviol glycosides, in particular when the ratio of rebaudioside B to total steviol glycosides in the blend ranges from 0.5% to about 50% and more preferably from about 5% to about 40%.

The afore-mentioned drawbacks associated with the use of steviol glycosides are still not overcome to a satisfactory extent. It is still desirable to obtain beverages having a much improved sweetness and aroma profile.

### BRIEF SUMMARY

Accordingly, it has been an object of the present disclosure to provide low-calorie beverages having been sweetened by use of steviol glycosides which, however, do not suffer from a bitter or licorice-like aftertaste and/or which do not cause a blunt or dry mouthfeel and/or which do not exhibit a delayed onset of the sensation of sweetness.

One embodiment provides a sweetening composition comprising rebaudioside A, rebaudioside B and rebaudioside D wherein, wherein based on the total weight of rebaudioside A, rebaudioside B and rebaudioside D, rebaudioside A is present in an amount in the range from 85.0 to 95.0 wt-%,rebaudioside B is present in an amount in the range from 0.2 to 1.2 wt-%, and rebaudioside D is present in an amount in the range from 4.8 to 13.8 wt-%.

A further embodiment provides a beverage, preferably a carbonated beverage that contains the sweetening compositions disclosed herein.

### DETAILED DESCRIPTION

The problems underlying the present disclosure have surprisingly been solved by a sweetening composition comprising, or in some cases consisting of, rebaudioside A, rebaudioside B and rebaudioside D wherein, based on the total weight of rebaudioside A, rebaudioside B and rebaudioside D,

rebaudioside A is present in an amount in the range from 85.0 to 95.0 wt-%;

rebaudioside B is present in an amount in the range from 0.2 to 1.2 wt-%; and

rebaudioside D is present in an amount in the range from 4.8 to 13.8 wt-%.

In another embodiment of the sweetening composition of the present disclosure, rebaudioside A is present in an amount in the range from 86.0 to 94.3 wt-%;

rebaudioside B is present in an amount in the range from 0.3 to 0.9 wt-%; and

rebaudioside D is present in an amount in the range from 5.4 to 13.1 wt-%.

According to one embodiment, the sweetening compositions having a very good mouthfeel, essentially no bitter aftertaste and no delayed onset are characterized in that, based on the total weight of rebaudioside A, rebaudioside B and rebaudioside D, rebaudioside A is present in an amount in the range from 90.5 to 94.0 wt-%,

rebaudioside B is present in amount in the range from 0.2 to 1.0 wt-%; and

rebaudioside D is present in amount in the range from 5.8 to 8.5 wt-%.

According to another embodiment, the described effects are also obtained by a sweetening composition in which, based on the total weight of rebaudioside A, rebaudioside B and rebaudioside D, rebaudioside A is present in an amount in the range from 90.9 to 94.4 wt-%,

rebaudioside B is present in amount in the range from 0.2 to 0.5 wt-% and

rebaudioside D is present in amount in the range from 5.4 to 8.6 wt-%.

Furthermore, it has been found that those sweetening compositions of the present disclosure exhibit superior results in terms of improved aroma profile and improved aftertaste in which said composition does not contain any steviol glycoside or derivatives other than rebaudioside A, rebaudioside B and rebaudioside D, if present in the sweetening composition, in an amount more than the amount of rebaudioside B.

In another embodiment, any steviol glycoside or derivatives other than rebaudioside A, rebaudioside B and rebaudioside D, if present in the sweetening composition, is in an amount less than the amount of rebaudioside B.

In one specific embodiment, the sweetening composition comprises no more rebaudioside C or no more rebaudioside E or no more rebaudioside F or no more stevioside (13-[(2-O-beta-D-Glucopyranosyl-alpha-D-glucopyranosyl)oxy]kaur-16-en-18-oic acid beta-D-glucopyranosyl ester) or no more dulcoside or no more rubusoside or no more steviolbioside (13-[(2-O-β-D-Glucopyranosyl-β-D-glucopyranosyl)oxy]kaur-16-en-18-oic acid) or no more of any other steviol glycoside different from rebaudioside A to F, stevioside, dulcoside, rubusoside and steviolbioside than rebaudioside B.

In another embodiment, said composition contains less rebaudioside C or less rebaudioside E or less rebaudioside F or less stevioside or less dulcoside or less rubusoside or less steviolbioside or less of any other steviolglycoside different from rebaudioside A to F, stevioside, dulcoside, rubusoside and steviolbioside than rebaudioside B.

In a preferred embodiment, said composition does not contain more of at least two compounds selected from the group consisting of rebaudioside C, rebaudioside E, rebaudioside F, stevioside, dulcoside, rubusoside, steviolbioside and of any other steviolglycoside different from rebaudioside A to F, stevioside, dulcoside, rubusoside and steviolbioside than rebaudioside B.

In a further embodiment, said composition contains less of at least two compounds selected from the group consisting of rebaudioside C, rebaudioside E, rebaudioside F, stevioside, dulcoside, rubusoside, steviolbioside and of any other steviolglycoside different from rebaudioside A to F, stevioside, dulcoside, rubusoside and steviolbioside than rebaudioside B.

In yet a further embodiment, said composition does not contain more of rebaudioside C, rebaudioside E, rebaudioside F, stevioside, dulcoside, rubusoside and steviolbioside and of any other steviolglycoside different from rebaudioside A to F, stevioside, dulcoside, rubusoside and steviolbioside than rebaudioside B.

In another embodiment, said composition contains less of rebaudioside C, rebaudioside E, rebaudioside F, stevioside, dulcoside, rubusoside and steviolbioside and of any other steviolglycoside different from rebaudioside A to F, stevioside, dulcoside, rubusoside and steviolbioside than rebaudioside B.

In further embodiments, those sweetening compositions are preferred in terms of improved aroma profile and improved aftertaste in which said composition, based on the total weight of rebaudioside A, rebaudioside B and rebaudioside D, does not contain more than 0.1 wt.-% rebaudioside C, rebaudioside E, rebaudioside F, stevioside, dulcoside, rubusoside or steviolbioside or more of any other steviol glycoside different from rebaudioside A to F, stevioside, dulcoside, rubusoside and steviolbioside.

In another embodiment, said composition, based on the total weight of rebaudioside A, rebaudioside B and rebaudioside D, contains less than 0.1 wt.-% rebaudioside C or less than 0.1 wt.-% rebaudioside E or less than 0.1 wt.-% rebaudioside F or less than 0.1 wt.-% stevioside or less than 0.1 wt.-% dulcoside or less than 0.1 wt.-% rubusoside or less than 0.1 wt.-% steviolbioside or less than 0.1 wt.-% of any other steviolglycoside different from rebaudioside A to F, stevioside, dulcoside, rubusoside and steviolbioside.

In yet another embodiment, said composition, based on the total weight of rebaudioside A, rebaudioside B and rebaudioside D, does not contain more than 0.1 wt.-% of at least two compounds selected from the group consisting of rebaudioside C, rebaudioside E, rebaudioside F, stevioside, dulcoside, rubusoside, steviolbioside and of any other steviolglycoside different from rebaudioside A to F, stevioside, dulcoside, rubusoside and steviolbioside.

In a further embodiment, said composition, based on the total weight of rebaudioside A, rebaudioside B and rebaudioside D, contains less than 0.1 wt.-% of at least two compounds selected from the group consisting of rebaudioside C, rebaudioside E, rebaudioside F, stevioside, dulcoside, rubusoside, steviolbioside and of any other steviolglycoside different from rebaudioside A to F, stevioside, dulcoside, rubusoside and steviolbioside.

In a further embodiment, said composition, based on the total weight of rebaudioside A, rebaudioside B and rebaudioside D, does not contain more than 0.1 wt.-% of rebaudioside C, rebaudioside E, rebaudioside F, stevioside, dulcoside, rubusoside and steviolbioside and of any other steviolglycoside different from rebaudioside A to F, stevioside, dulcoside, rubusoside and steviolbioside.

In a further embodiment, said composition, based on the total weight of rebaudioside A, rebaudioside B and rebaudioside D, contains less than 0.1 wt.-% of rebaudioside C, rebaudioside E, rebaudioside F, stevioside, dulcoside, rubusoside and steviolbioside and of any other steviolglycoside different from rebaudioside A to F, stevioside, dulcoside, rubusoside and steviolbioside. Those compositions are also preferred which do not contain rebaudioside C, rebaudioside E, rebaudioside F, stevioside, dulcoside, rubusoside and steviolbioside and also not any other steviolglycoside different from rebaudioside A to F, stevioside, dulcoside, rubusoside and steviolbioside.

In one embodiment, the sweetening composition, based on the total weight of rebaudioside A, rebaudioside B and rebaudioside, is consisting of rebaudioside A in an amount in the range from 90.9 to 94.4 wt-%, rebaudioside B in an amount in the range from 0.2 to 0.5 wt-% and rebaudioside D in an amount in the range from 5.4 to 8.6 wt-%.

In another embodiment, the sweetening composition, based on the total weight of rebaudioside A, rebaudioside B and rebaudioside D, is consisting of rebaudioside A in an amount in the range from 86.0 to 94.3 wt-%, rebaudioside B in an amount in the range from 0.3 to 0.9 wt-%, and rebaudioside D in an amount in the range from 5.4 to 13.1 wt-%.

Yet in another embodiment, the sweetening composition, based on the total weight of rebaudioside A, rebaudioside B and rebaudioside D, is consisting of rebaudioside A in an amount in the range from 90.5 to 94.0 wt-%, rebaudioside B in amount in the range from 0.2 to 1.0 wt-%, and rebaudioside D in amount in the range from 5.8 to 8.5 wt-%.

Due to the sweetening power of rebaudioside compounds, the sweetening compositions of the present disclosure can be void of any sweet-tasting natural carbohydrates and/or any sweet-tasting sugar alcohols. However, it has surprisingly been found that with some beverages the sweetening composition of the present disclosure furnishes even better results in particular in terms of mouthfeel, aftertaste and aroma profile if it comprises at least one natural sweet-tasting carbohydrate, in particular a natural sweet-tasting monosaccharide and/or disaccharide, and/or at least one sweet-tasting sugar alcohol, preferably at least one natural sweet-tasting carbohydrate and no sweet-tasting sugar alcohol.

Accordingly, the problem of the present disclosure has also been solved by a sweetening composition comprising rebaudioside A, rebaudioside B, rebaudioside D, at least one natural sweet-tasting carbohydrate, in particular a natural sweet-tasting monosaccharide and/or disaccharide, and/or at least one sweet-tasting sugar alcohol, and which is essentially free of rebaudioside C, rebaudioside E, rebaudioside F, stevioside, dulcoside, rubusoside, steviolbioside and of any other steviolglycoside different from rebaudioside A to F, stevioside, dulcoside, rubusoside or steviolbioside, or, preferably, which is essentially free of rebaudioside C, rebaudioside E, rebaudioside F, stevioside, dulcoside, rubusoside, steviolbioside and of any other steviolglycoside different from rebaudioside A to F, stevioside, dulcoside, rubusoside and steviolbioside.

Steviolglycosides such as rebaudioside A, rebaudioside B, rebaudioside D, rebaudioside C, rebaudioside E, rebaudioside F, stevioside, dulcoside, rubusoside and steviolbioside can be detected/determined according to HPLC-UV as specified in JECFA (2010) Steviol Glycosides, FAO JECFA Monograph 10, FAO, Rome.

With the present disclosure it is also possible to not only make use of highly purified product samples of individual rebaudiosides A, B and D, but to also employ crude product samples of rebaudiosides A, B and D. The compositions of the present disclosure can for example also contain residual plant components or residual moisture. However, it is preferred to make use of purified rebaudioside A, B and D starting components. According to the present disclosure, 100 g of such purified rebaudioside may in some embodiments contain about 0.1 g or less of other steviol glycosides as described herein.

The composition of the present disclosure preferably contains at least one natural sweet-tasting carbohydrate, in particular a natural sweet-tasting monosaccharide and/or disaccharide, and no sweet-tasting sugar alcohol.

Exemplary, sweet-tasting natural monosaccharides are selected from the group consisting of fructose, glucose, mannose, rhamnose, xylose, tagatose, and galactose or mixtures thereof. Exemplary sweet-tasting naturally disaccharides are selected from the group consisting of sucrose, lactose, and maltose or mixtures thereof. And, exemplary sweet-tasting sugar alcohols are selected from the group consisting of erythritol, glycerol, lactitol, maltitol, mannitol, sorbitol, xylitol, and galactitol or mixtures thereof. It has also surprisingly been found that sweetening compositions of the present disclosure or beverages of the present disclosure which also contain at least one sweet-tasting monosaccharide, preferably glucose, and/or at least one sweet-tasting disaccharide, preferably sucrose, furnish or have, resp., an improved aroma profile and a rather natural sweetness sensation as obtained when using sweet-tasting carbohydrates alone in typical amounts furnishing a caloric content of from 3.6 to 3.9 kcal/g.

Sweetening compositions which further comprise at least one thickening agent and/or at least one organic acid and/or at least one inorganic acid, in particular phosphoric acid, have been found to provide beverages having an improved mouthfeel and/or freshness. The improvement in mouthfeel with the compositions of the present disclosure can also be caused by the use of thickening agents. Alternatively, or in combination, physiologically acceptable salts of the aforementioned acids can be used as well. Preferred results in terms of aroma development and perception of sweetness can be obtained when fumaric acid, gluconic acid, glycolic acid, mandelic acid, oxalic acid and salicylic acid, lactic acid, tartaric acid, anisic acid, malic acid or citric acid or a mixture of these acids is used. Preferably malic acid or citric acid or a mixture of malic acid and citric acid are present in the sweetening compositions or the beverages of the present disclosure. Here, it has been found to be advantageous to make us of two organic acids, preferably malic acid and citric acid. The relative amounts of the organic acids, in particular of a pair of organic acids, can be varied in wide ranges. According to another embodiment these two organic acids, in particular malic acid and citric acid, are employed in a 1:1 weight ratio. Moreover, with malic acid it has surprisingly been found that with the sweetening compositions of the present disclosure a mild aroma profile can be obtained. Moreover, it has also been surprisingly found that by concomitant use of malic acid and another organic acid, in particular, citric acid a rather fruity and fresh taste impression can be obtained. Both malic acid and citric acid, alone and in combination, are suited to improve the sweetness and acid profile of beverages containing the sweetening compositions of the present disclosure and are also able to generate a pleasant development of the overall aroma profile and also of the sweetness sensation.

Suitable thickening agents are selected from the group consisting of starch, starch-based thickeners, xanthan, pectins, agar agar, carrageenan, alginic acid and locust bean gum or mixtures thereof. Suitable organic acids are selected from the group consisting of citric acid, malic acid, tartaric acid, fumaric acid, gluconic acid, lactic acid, glycolic acid, mandelic acid, oxalic acid and salicylic acid or mixtures thereof.

The sweetening compositions of the present disclosure can also be provided with at least one flavoring ingredient. Suitable flavoring ingredients are selected from the group consisting of galangal, cocoa, cinnamon, lemon, lemon juice concentrate, coca leaf, orange, orange oil, banana, grape, pear, pineapple, bitter almond, corn mint, pine, cardamom, mace, clove, lime, lime oil, nutmeg, nutmeg oil, mustard seeds, mustard seed oil, caramel, rosemary, pepper, honey, ginger, vanilla, licorice, licorice extract, cola nut, cola nut extract or mixtures thereof. The sweetening compositions of the present disclosure in one embodiment can also comprise at least one artificial sweetener, in particular aspartame, sucralose, neotame, alitame, glucin, acesulfame potassium, cyclamate, saccharine or mixtures thereof.

In particular, if the sweetening composition of the present disclosure shall be used for a preparation of an energy drink, it can also contain taurine and/or caffeine. Accordingly, the sweetening compositions of the present disclosure can as such also be used for energy drinks.

The sweetening compositions of the present disclosure can also comprise, for example when used with energy drinks, further ingredients such as sodium citrate, glucoronolactone, inositol, at least one vitamin, e.g., niacin, pantothenic acid, vitamin B6, vitamin B12, riboflavin, caustic caramel, caustic sulfite caramel, ammonia caramel, sulfite ammonia caramel or ascorbic acid or mixtures thereof. The sweetening composition of the present disclosure can be used for sweetening beverages, in particular soft drinks or energy drinks The beneficial effects coming along with the use of the sweetening composition of the present disclosure can in particular also be accomplished with carbonated beverages.

The sweetening compositions of the present disclosure as well as the beverages of the present disclosure, e.g., soft drinks or energy drinks, in one embodiment can also comprise common additives such as amino acids, coloring agents, bulking agents, modified starches, texturizers, preservatives, antioxidants, emulsifiers, stabilizers, gelling agents or arbitrary mixtures thereof.

Interestingly, the sweetening compositions of the present disclosure are also suited to prepare precursor compositions in the form of a syrup which can be easily stored and transported and can be used on demand for the preparation of in particular carbonated beverages.

The problem underlying the present disclosure has also been solved by a beverage comprising the sweetening composition of the present disclosure.

Suitable beverages according to further embodiments are characterized in that rebaudioside A, B and D in combination are present in the beverage in a concentration in the range from 0.01 to 1.0 g/l, preferably from 0.05 to 0.75 g/l and more preferably from 0.1 to 0.6 g/l (determined at ambient temperature and 1 bar). According to another embodiment rebaudioside A, B and D, in combination, are present in beverages, which are void of natural sweet-tasting carbohydrates and/or sweet-tasting sugar alcohols, in particular void of both, in a concentration in the range from 0.05 to 0.5 g/l, preferably from 0.075 to 0.3 g/l and more preferably from 0.1 to 0.175 g/l. And, according to still another embodiment, rebaudioside A, B and D, in combination, are present in beverages, which contain at least one natural sweet-tasting carbohydrate and/or at least one sweet-tasting sugar alcohol, in particular at least one natural sweet-tasting carbohydrate but no sweet-tasting sugar alcohol, in a concentration in the range from 0.075 to 0.5 g/l, preferably from 0.1 to 0.4 g/l and more preferably from 0.18 to 0.3 g/l.

Beverages of the present disclosure having an improved mouthfeel and also an improved aroma profile preferably contain sweet-tasting natural carbohydrates and/or sweet-tasting sugar alcohols. In another embodiment, the sweet-tasting natural carbohydrates and the sweet-tasting sugar alcohols are present in combination in the beverages of the present disclosure in a concentration not above 40 g/l, preferably in the range from 5 g/l to 35 g/l and more preferably in the range from 10 g/l to 25 g/l (determined at ambient temperature and 1 bar). Ambient temperature in the meaning of the present disclosure shall mean room temperature, i.e., a temperature in the range from 20° C. to 25° C.

The problem of the present disclosure has also been solved by a method comprising the steps of a) providing a sweetening composition according to the present disclosure, b) providing water, and c) mixing components provided under a) and b).

In case a carbonated beverage shall be prepared according to the process of the present disclosure, a carbonating step (step d) has to be added to said process. According to another embodiment, the process of the present disclosure can further comprise the step of adding at least one thickening agent, at least one sweet-tasting natural carbohydrate, at least one sweet-tasting sugar alcohol, at least one organic acid and/or at least one flavoring ingredient to the sweetening composition or to a mixture comprising water and the sweetening composition of the present disclosure. The aforementioned components may also be added to water prior to mixing with the sweetening composition of the present disclosure. Here, the definitions provided above for thickening agent, sweet-tasting natural carbohydrate, sweet-tasting sugar alcohol, organic acid and flavoring ingredient are applicable as well both in terms of general information and further embodiments.

Furthermore, it is also possible that the sweet-tasting natural carbohydrates and/or at least one sweet-tasting sugar alcohol are added to the mixture comprising water and the sweetening composition prior to and/or after the carbonating step, preferably prior to the carbonating step.

With the present disclosure it has been surprisingly found that sweetening compositions containing stevia glycosides are accessible which do not exhibit a slow onset, which do not have a bitter aftertaste and which also do not have a metallic aftertaste. Moreover, it has surprisingly been found that with the sweetening compositions of the present disclosure an aroma or sweetening profile can be accomplished which resembles that of beverages having been sweetened with natural sugars, even with carbonated beverages. It is thus possible with the sweetening composition of the present disclosure to prepare beverages, in particular carbonated beverages such as soft drinks and energy drinks, which though having a significantly reduced caloric content exhibit an improved sweetness and aroma profile and which in another embodiment also do not differ significantly in their taste from conventional beverages having been sweetened with natural sugars and/or artificial sweeteners. This also includes that a sweetened sensation is perceived by the consumer already at the very beginning Without being bound by theory, it is believed that this effect is also based on the concomitant use of small amounts of rebaudioside B. In addition, with the sweetening composition of the present disclosure beverages can be obtained which do not have an insipid or blunt taste or mouthfeel. Interestingly, the above-mentioned advantages are accomplished as long as the relative amounts of rebaudioside A, rebaudioside B and rebaudioside D in the composition of the present disclosure are used essentially irrespective of the total amount of the sweetening composition of the present disclosure used with beverages.

The beverages of the present disclosure comprise, in particular carbonated, soft drinks and energy drinks. Suitable soft drinks also include cola-flavored soft drinks, wherein cola-flavored soft drinks also encompass cola-flavored-type soft drinks. Also these beverages, when being sweetened with the sweetening composition in accordance with the present invention, do not or do essentially not exhibit a slow onset of the sensation of sweetness but provide a rather harmonic sweetening profile and do not or do essentially not have a bitter or licorice-like aftertaste.

It is another benefit of sweetening compositions of the present disclosure that beverages can be obtained which contain natural sugars such as sweet-tasting carbohydrates and/or sweet-tasting sugar alcohols in a very reduced amount. It is possible to reduce the amount of these natural sugars by for example at least 50 wt.-%, preferably by at least 60 wt.-% and more preferably by at least 30 wt.-% vis-à-vis beverages which do not contain the sweetening compositions of the present disclosure.

And, with the present disclosure it has been accomplished to provide carbonated low-calorie soft drinks and energy drinks which satisfy the sensoric demands of the consumer while simultaneously complying with the provisions of the Commission Regulation (EU) No. 1131/2011.

### EXAMPLE 1

The effects obtainable with the sweetening compositions of the present disclosure were checked by way of blind tastings. A great variety of recipes were tested and subjected to blind tasting by several probands in each case. For each tasting said probands had to evaluate the aroma profile, sweetness, acidity, smell, finish, acerbity and aftertaste (metallic, adstringent, licorice-like).

As a reference sample, the Red Bull Energy Drink was used. The individual samples were encoded based on ISO 8587:2006. This standard was also used to place a series of test samples in rank order based on the afore-mentioned sensory evaluation. ISO 8587:2006 allows for assessing differences among several samples based on the intensity of a single attribute, of several attributes or on an overall impression. This ISO standard is well established for the sorting of samples and for the determination of the influence on intensity levels of one or more parameters in a consumer tasting. That is, the probands had to examine at least three test samples in an arbitrary sequence. There were in total six tasting flights which were tested by a tasting panel. It was found that, among others, satisfactory results were obtained by carbonated beverages containing a sweetening composition comprising about 89 wt-% rebaudioside A, about 0.8 wt-% rebaudioside B and about 10.2 wt-% rebaudioside D, and also by a sweetening composition comprising about 92 wt-% rebaudioside A, about 0.8 wt-% rebaudioside B and about 7.2 wt-% rebaudioside D as well as by a sweetening composition comprising about 86.7 wt-%, rebaudioside A, about 0.8 wt-%, rebaudioside B and about 12.5% rebaudioside D. Particularly satisfactory results were obtained in terms of sweetening profile and aroma profile if natural sweet-tasting carbohydrates such as glucose and sucrose were present, however, in significantly reduced amounts compared to the reference sample (preferably not more than 30 wt-% of sugar). It was also found that by addition of organic acids such as malic acid and citric acid the overall taste impression could be improved. The compositions which successfully passed the tasting test did not exhibit a bitter, metallic and licorice-like aftertaste, did not have a delayed onset, provided a comfortable aroma profile and mouthfeel and were essentially indistinguishable from the reference sample, in particular as to its sweetening profile.

### EXAMPLE 2

Additional sensory tests were conducted on the basis of ISO 5492 while cross-validation (comparative testing by pairs), i.e., the tasting was done in accordance with ISO 5495:2007. The test panel was made up of more than 20 probands. The statistical significance value “alpha” (also known as level of significance or probability of error) was determined to be 0.05. A commercial carbonated beverage was used for all test samples, however, its sugar content was completely replaced by mixtures solely containing Rebaudioside A, B and D; no other Rebaudiosides were added to the test samples. With all test samples, the overall concentration of Rebaudiosides was always in the range from 0.01 to 1.0 g/l. Only those trial pairs were compared with each other in which the ratio of two Rebaudiosides has been kept constant. All test samples were encoded and randomized by use of three-digit random numbers. It was found that, among others, satisfactory results including more harmonic sweetening profile and less bitter or licorice-like aftertaste were obtained by carbonated beverages containing a sweetening composition comprising about 90.04 wt-% rebaudioside A, about 0.36 wt-% rebaudioside B and about 9.60 wt-% rebaudioside D, and also by a sweetening composition comprising about 90.0 wt-% rebaudioside A, about 0.70 wt-% rebaudioside B and about 9.30 wt-% rebaudioside D as well as by a sweetening composition comprising about 90.0 wt-%, rebaudioside A, about 0.36 wt-%, rebaudioside B and about 9.64% rebaudioside D and also by a sweetening composition comprising about 87.54 wt-%, rebaudioside A, about 0.44 wt-%, rebaudioside B and about 12.01% rebaudioside D.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary, to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A sweetening composition comprising rebaudioside A, rebaudioside B and rebaudioside D wherein, based on the total weight of rebaudioside A, rebaudioside B and rebaudioside D,
rebaudioside A is present in an amount in the range from 85.0 to 95.0 wt-%;
rebaudioside B is present in an amount in the range from 0.2 to 1.2 wt-%; and
rebaudioside D is present in an amount in the range from 4.8 to 13.8 wt-%.

2. The sweetening composition according to claim 1, wherein, based on the total weight of rebaudioside A, rebaudioside B and rebaudioside D,
rebaudioside A is present in an amount in the range from 86.0 to 94.3 wt-%;
rebaudioside B is present in an amount in the range from 0.3 to 0.9 wt-%; and
rebaudioside D is present in an amount in the range from 5.4 to 13.1 wt-%.

3. The sweetening composition according to claim 1, wherein, based on the total weight of rebaudioside A, rebaudioside B and rebaudioside D,
rebaudioside A is present in an amount in the range from 90.5 to 94.0 wt-%;
rebaudioside B is present in amount in the range from 0.2 to 1.0 wt-%; and
rebaudioside D is present in amount in the range from 5.8 to 8.5 wt-%.

4. The sweetening composition of claim 1 wherein, based on the total weight of rebaudioside A, rebaudioside B and rebaudioside D,
rebaudioside A is present in an amount in the range from 90.9 to 94.4 wt-%;
rebaudioside B is present in amount in the range from 0.2 to 0.5 wt-%; and
rebaudioside D is present in amount in the range from 5.4 to 8.6 wt-%.

5. The sweetening composition according to claim 1 wherein said composition does not contain more rebaudioside C or more rebaudioside E or more rebaudioside F or more stevioside or more dulcoside or more rubusoside or more steviolbioside or more of any other steviol glycoside different from rebaudioside A to F, stevioside, dulcoside, rubusoside and steviolbioside than rebaudioside B,
or
wherein said composition contains less rebaudioside C or less rebaudioside E or less rebaudioside F or less stevioside or less dulcoside or less rubusoside or less steviolbioside or less of any other steviolglycoside different from rebaudioside A to F, stevioside, dulcoside, rubusoside and steviolbioside than rebaudioside B,
or
wherein said composition does not contain more of at least two compounds selected from the group consisting of rebaudioside C, rebaudioside E, rebaudioside F, stevioside, dulcoside, rubusoside, steviolbioside and of any other steviolglycoside different from rebaudioside A to F, stevioside, dulcoside, rubusoside and steviolbioside than rebaudioside B,
or
wherein said composition contains less of at least two compounds selected from the group consisting of rebaudioside C, rebaudioside E, rebaudioside F, stevioside, dulcoside, rubusoside, steviolbioside and of any other steviolglycoside different from rebaudioside A to F, stevioside, dulcoside, rubusoside and steviolbioside than rebaudioside B,
or
wherein said composition does not contain more of rebaudioside C, rebaudioside E, rebaudioside F, stevioside, dulcoside, rubusoside and steviolbioside and of any other steviolglycoside different from rebaudioside A to F, stevioside, dulcoside, rubusoside and steviolbioside than rebaudioside B,
or
wherein said composition contains less of rebaudioside C, rebaudioside E, rebaudioside F, stevioside, dulcoside, rubusoside and steviolbioside and of any other steviolglycoside different from rebaudioside A to F, stevioside, dulcoside, rubusoside and steviolbioside than rebaudioside B.

6. The sweetening composition according to claim 1 wherein the composition is essentially free of any sweet-tasting natural carbohydrates and/or in that the composition is essentially free of any sweet-tasting sugar alcohols.

7. The sweetening composition according to claim 1 further comprising at least one natural sweet-tasting carbohydrate, a natural sweet-tasting monosaccharide or disaccharide, or at least one sweet-tasting sugar alcohol.

8. The sweetening composition according to claim 1 wherein said composition, based on the total weight of rebaudioside A, rebaudioside B and rebaudioside D, does not contain more than 0.1 wt.-% rebaudioside C, rebaudioside E, rebaudioside F, stevioside, dulcoside, rubusoside or steviolbioside or more of any other steviolglycoside different from rebaudioside A to F, stevioside, dulcoside, rubusoside and steviolbioside,
or
wherein said composition, based on the total weight of rebaudioside A, rebaudioside B and rebaudioside D, contains less than 0.1 wt.-% rebaudioside C or less than 0.1 wt.-% rebaudioside E or less than 0.1 wt.-% rebaudioside F or less than 0.1 wt.-% stevioside or less than 0.1 wt.-% dulcoside or less than 0.1 wt.-% rubusoside or less than 0.1 wt.-% steviolbioside or less than 0.1 wt.-% of any other steviolglycoside different from rebaudioside A to F, stevioside, dulcoside, rubusoside and steviolbioside,
or
wherein said composition, based on the total weight of rebaudioside A, rebaudioside B and rebaudioside D, does not contain more than 0.1 wt.-% of at least two compounds selected from the group consisting of rebaudioside C, rebaudioside E, rebaudioside F, stevioside, dulcoside, rubusoside, steviolbioside and of any other steviolglycoside different from rebaudioside A to F, stevioside, dulcoside, rubusoside and steviolbioside,
or
wherein said composition, based on the total weight of rebaudioside A, rebaudioside B and rebaudioside D, contains less than 0.1 wt.-% of at least two compounds selected from the group consisting of rebaudioside C, rebaudioside E, rebaudioside F, stevioside, dulcoside, rubusoside, steviolbioside and of any other steviolglycoside different from rebaudioside A to F, stevioside, dulcoside, rubusoside and steviolbioside,
or
wherein said composition, based on the total weight of rebaudioside A, rebaudioside B and rebaudioside D, does not contain more than 0.1 wt.-% of rebaudioside C, rebaudioside E, rebaudioside F, stevioside, dulcoside, rubusoside and steviolbioside and of any other steviolglycoside different from rebaudioside A to F, stevioside, dulcoside, rubusoside and steviolbioside,
or
wherein said composition, based on the total weight of rebaudioside A, rebaudioside B and rebaudioside D, contains less than 0.1 wt.-% of rebaudioside C, rebaudioside E, rebaudioside F, stevioside, dulcoside, rubusoside and steviolbioside and of any other steviolglycoside different from rebaudioside A to F, stevioside, dulcoside, rubusoside and steviolbioside.

9. The sweetening composition according to claim 7 wherein the sweet-tasting natural monosaccharide is fructose, glucose, mannose, rhamnose, xylose, tagatose, and galactose, or a mixture thereof, or wherein the sweet-tasting natural disaccharide is sucrose, lactose, maltose or a mixture thereof, or wherein the sweet-tasting sugar alcohol is erythritol, glycerol, lactitol, maltitol, mannitol, sorbitol, xylitol, galactitol or a mixture thereof.

10. The sweetening composition according to claim 1 further comprising at least one thickening agent and/or at least one organic acid, or a salt thereof and/or at least one inorganic acid, or a salt thereof.

11. The sweetening composition according to claim 10, wherein the thickening agent is starch, starch-based thickeners, xanthan, pectin, agar agar, carrageenan, alginic acid and locust bean gum or a mixture thereof, and/or wherein the organic acid is citric acid, malic acid, tartaric acid, fumaric acid, gluconic acid, lactic acid, glycolic acid, mandelic acid, oxalic acid, salicylic acid or a mixture thereof, or wherein the inorganic acid is phosphoric acid.

12. The sweetening composition according to claim 1 further comprising one or more flavoring ingredients selected from the group consisting of galangal, cocoa, cinnamon, lemon, lemon juice concentrate, coca leaf, orange, orange oil, corn mint, pine, cardamom, mace, clove, lime, lime oil, nutmeg, nutmeg oil, mustard seeds, mustard seed oil, caramel, rosemary, pepper, honey, ginger, vanilla, licorice, licorice extract, cola nut, and cola nut extract.

13. The sweetening composition according to claim 1 further comprising one or more artificial sweeteners selected from the group consisting of aspartame, sucralose, neotame, alitame, glucin, acesulfame potassium, cyclamate, and saccharine.

14. The sweetening composition according to claim 1 further comprising one and more ingredients selected from the group consisting of sodium citrate, glucoronolactone, inositol, and at least one vitamin selected from the group consisting of niacin, pantothenic acid, vitamin B6, vitamin B12, and riboflavin, caustic caramel, caustic sulfite caramel, ammonia caramel, sulfite ammonia caramel, and ascorbic acid.

15. The sweetening composition according to claim 1 further comprising taurine and/or caffeine.

16. A beverage comprising the sweetening composition according to claim 1.

17. The beverage according to claim 16 wherein rebaudioside A, B and D in combination are present in the beverage in a concentration in the range from 0.01 to 1.0 g/l, preferably from 0.05 to 0.75 g/l and more preferably from 0.1 to 0.6 g/l.

18. The beverage according to claim 16 wherein the sweet-tasting natural carbohydrates and the sweet-tasting sugar alcohols are present in combination in the beverage in a concentration not above 40 g/l, preferably in the range from 5 g/l to 35 g/l and more preferably in the range from 10 g/l to 25 g/l.

19. The beverage according to claim 16, wherein the beverage is a soft drink, a cola-flavored or cola-flavored-type soft drink, or an energy drink.

20. The beverage according to claim 16, wherein the beverage is carbonated.

21. A process for preparing a beverage according to claim 16 comprising the steps of:
a) providing a sweetening composition according to claim 1;
b) providing water; and
c) mixing components provided under a) and b).

22. The process according to claim 21 further comprising the step of d) carbonating the beverage.

23. The process according to claim 21 further comprising the step of adding at least one thickening agent, at least one sweet-tasting natural carbohydrate, at least one sweet-tasting sugar alcohol, at least one organic acid and/or at least one flavoring ingredient to the sweetening composition prior to mixing with water or to a mixture comprising water and the sweetening composition and/or to water prior to mixing with the sweetening composition.

24. The process according to claim 22 wherein the sweet-tasting natural carbohydrates and/or at least one sweet-tasting sugar alcohol, are added to the mixture comprising water and the sweetening composition prior to and/or after the carbonating step.

25. A sweetening composition consisting of:
rebaudioside A in an amount in the range from 85.0 to 95.0 wt-%;
rebaudioside B in an amount in the range from 0.2 to 1.2 wt-%; and
rebaudioside D in an amount in the range from 4.8 to 13.8 wt-%.
